(19) United States
(12) Patent Application Publication
(10) Pub. No.: US 2026/0264437 A1
(43) Pub. Date: Sep. 10, 2026

(54) DECORATED PANEL AND METHOD FOR PRODUCING IT

(71) Applicant: Giorgio MACOR, Villorba (IT)

(72) Inventor: Giorgio MACOR, Villorba (IT)

(21) Appl. No.: 19/162,451

(22) PCT Filed: Mar. 6, 2024
(86) PCT No.: PCT/IB2024/052146

§ 371 Date: Sep. 5, 2025

(30) Foreign Application Priority Data
Mar. 6, 2023 (IT) 102023000004023

(51) Int. Cl. B41M 5/00; A47B 96/20; B41M 7/00; B44C 1/24; B44C 5/04; E04F 13/08; E04F 15/10

(52) U.S. Cl. CPC B41M 5/0041; B41M 7/0045; B44C 5/04; A47B 96/205; B44C 1/24; E04F 13/0866; E04F 15/107

(57) ABSTRACT

The present invention refers to a decorated panel composed as follows: a substrate; a decorative layer applied to at least part of the substrate; a photocrosslinkable formulation applied directly or indirectly on a part of the substrate and/or the decorative layer, i. e. with the interposition of further layers of intermediate material on at least a part of the substrate and in one or more layers, containing at least one photocrosslinkable resin; at least one thermoplastic resin; at least one polymerization initiator including but not limited to UV photoinitiators, organic peroxides, Electron Beam. According to one embodiment at least the photocrosslinkable formulation is provided with a three-dimensional surface conformation such as texturing or embossing which is obtained alternatively or in combination by mechanical embossing and/or digital embossing. The invention also has as its object a method for producing a panel decorated with the aforementioned formulation.

### FIELD OF INVENTION

The present invention refers to a photo-crosslinkable formulation and a decorated panel made with such formulation.

The present invention also refers to a method for making such a panel and the machinery to implement it.

In particular, the invention concerns a floor decorated and textured by digital printing, the various layers of coating protecting it and a method for making it.

The present invention fits into the technical sector of materials and in particular to create panels for the production of floors, coverings, furniture and more generally for architectural and design surfaces.

The present invention exploits the combination of traditional technologies, which offer high mechanical, chemical-physical properties, low costs and the versatility of digital technologies which allow total customization and high precision.

### STATE OF ART

The panels for the production of flooring and furniture which reproduce wood and other natural materials in color and feel are generally made of wood-derived materials such as HDF, MDF and chipboard or synthetic materials such as polyester, PVC (SPC, LVT, WPC) and recently polyolefins such as PE and PP.

In the case of traditional floors made of wood and derivatives (MDF/HDF/chipboard/plywood) the decoration printed on paper is applied to the support and normally protected by the application of amino-plastic resins. The process takes place in continuous or discontinuous presses through the application of pressure and heat. The surface obtained is extremely resistant to scratches and abrasion. The product thus obtained is commonly called laminate.

In the case of synthetic floors, often PVC-based, such as LVT (Luxury Vinyl Tile), the decoration printed on plastic film is applied to the support and normally protected by applying a wear layer consisting of a thick film (300-500μ) of PVC. The process occurs through the use of pressure and heat, using continuous presses, discontinuous presses, engraved cylinders. The surface is then generally finished by applying a photo-crosslinkable coating to obtain the desired gloss and impart resistance to scratches, chemical resistance and stains. Alternatively, photocross-linkable formulations are used which are embossed by applying and simultaneously irradiating engraved elements transparent to UV light, for example through the use of SAPPI embossing films/papers. Another technology involves the use of hot-melt formulations which are applied to the surface to be protected and are subsequently embossed with engraved molds or cylinders. An example of this technology is HotCoating by Kleiberit (DE) which however has limitations as the hot-melt is of a polyurethane nature which takes 48-96 hours to crosslink, and the decorated panels require a long time before they can be mechanically processed.

Digital printing and in particular inkjet printing is increasingly establishing itself in industrial sectors, replacing traditional methods based on analogue printing. The advantages of digital printing are considerable and include high flexibility, the possibility of producing short runs and reduction in consumable waste.

In particular, the reproduction of wood and stone on various materials represents a typical application of digital printing to produce floors, furniture panels, skirting boards, profiles and in general in the field of design and architecture.

Industrial digital printing for direct substrate decoration (direct-to-board) generally uses photo-crosslinkable inks, which once polymerized, do not present thermoplastic characteristics and consequently cannot be used with the lamination techniques described previously as adhesion between the protective and decorative layers would not be achieved. On the other hand, direct decoration is increasingly spreading in the market, and it is necessary to develop a specific protection cycle for synthetic and non-synthetic materials, which can offer the desired characteristics of resistance to abrasion, scratches and other properties as per the EN 15468:2016 and/or EN 16511:2019 standards. Furthermore, the cycle must be texturizable using traditional analogue technologies or better yet, using digital texturing technologies, such as those described in WO2018069874A1 and WO2020039361A1.

The photo-crosslinkable coatings normally used for the protection of wooden floors (parquet) do not have sufficient anti-abrasion characteristics and to improve it, it is therefore necessary to use substances such as aluminum oxide in the formulation and apply considerable amount, around 100-200 g/m2.

After polymerization, photo-crosslinkable coatings show shrinkage of around 8-15% by volume, causing deformation of the substrate (defined as bending/cupping/curling). This phenomenon is strongly accentuated in the case of plastic flooring and even more so when the material is tested, as per standards, for dimensional stability for 6 hours at 80° C.

It is therefore necessary to develop a formulation and a coating cycle capable of protecting the underlying decoration from abrasion and at the same time being flexible to avoid deformation of the panel.

In this GLOSSARY the technical meanings of the terms used in this description and in the claims are better defined:
Texturing/Embossing/Embossing: creation of a three-dimensional structure that can be both positive and negative.
Bending/Curling/Cupping: deformation of a substrate resulting from the application of other layers on it such as coatings, inks, adhesives, plastic films.

Normally the deformation is accentuated by heat.
Coating/Coating/Lacquer: product intended to protect and/or decorate and/or improve the aesthetics of a substrate.
Photo-crosslinking/photo-curing/radiation-curing/energy-curing: crosslinking reaction in the presence or absence of photoinitiators, induced by irradiation using energy radiation such as, in particular but not limited to, UV bulb or LED lamps, electron beam and the like.

### SUMMARY OF THE INVENTION

A first aspect of the invention is the creation of a photo-crosslinkable formulation with anti-abrasive and/or anti-scratch properties used to protect a substrate capable of offering characteristics of resistance to abrasion and scratches and whose surface is made three-dimensional by means of mechanical embossing and/or by means of digital texturing, for example by inkjet.

In a further aspect of the invention, a photo-crosslinkable formulation of the same type mentioned above is formulated with anti-abrasive and/or anti-scratch properties and with plasticity and/or elasticity characteristics capable of limiting the deformation effect already mentioned previously. This deformation defined as (bending/cupping/curling) is due to the shrinkage of the photo-crosslinkable formulations and is accentuated by heat. The deformation can be both longitudinal and transversal and in addition to heat it is accentuated by the amount of photo-crosslinkable formulation applied. On the other hand, as mentioned previously, the high mechanical resistance characteristics required by the flooring imply high quantities applied which only worsen this phenomenon.

The coating cycle object of the invention involves the use of hybrid systems with thermoplastic characteristics and, for this purpose, the use of photo-crosslinkable resins in combination with non-photo-crosslinkable thermoplastic resins is particularly effective.

In accordance with a further aspect of the invention, the formulation object of the invention can be used as a base for one or more layers, including optional layers, making up the coating cycle, such as: adhesion primer, printing primer, finishing layer.

In accordance with a further aspect of the invention, the formulation object of the invention is made three-dimensional by means of embossing technologies, both analogue, such as static pressing, continuous pressing (eg double belt presses), engraved cylinders, and by means of digital, such as digital texturing by means of texturing inkjet fluids. In the case of discontinuous pressing, mechanical embossing involves the use of engraved molds showing the positive structure of the desired texture, while in continuous pressing double belt presses are normally used (produced for example by HYMMEN DE) in which the embossing belt is engraved or a further embossing element such as a ribbon or film is applied to the embossing belt (e.g. SAPPI embossing films/papers); finally, again for continuous pressing, engraved cylinders are used which show the positive structure of the desired texture.

Digital texturing involves localized applications, defined by digital templates, of texturizing fluid on the surface of the formulation that is the subject of the invention. The texturizing liquid is capable of deforming in a controlled manner and/or modifying the chemical-physical characteristics of the formulation in the areas on which it is applied.

Examples of these technologies will be better described later and already described in applications WO2018069874A1 and WO2020039361A1.

### DETAILED DESCRIPTION OF THE INVENTION

The invention consists of a decorated panel made up of at least one support comprising two opposite faces spaced by a predetermined thickness and on at least some areas and/or the entire surface of one of said faces, in particular the front face, it is applied directly or indirectly at least one anti-wear and/or anti-scratch layer, consisting of a photo-crosslinkable formulation comprising:
i. At least one photo-crosslinkable resin;
ii. At least one thermoplastic resin;
iii. At least one polymerization initiator, including but not limited to UV photoinitiators, organic peroxides, electron beam.

The panel can be made of different materials such as wood and derivatives (MDF/HDH/Chipboard/OSB), polymers such as PVC and derivatives (SPC/LVT/WPC), polyolefins (PP, PE), polyester, inorganic materials (calcium silicate, MgO), metals and combinations thereof. To reduce weight, the panel material and in particular the polymers are expanded/foamed. The expansion may be due to the use of a blowing agent such as ADC, rather than the use of a gas such as nitrogen.

The thickness of the support depends on the application and for example for floors it is typically 3-8 mm while for furniture it is 15-30 mm.

Furthermore, the method object of the invention can be applied to thin materials, such as plastic films (particularly PET, PP, BOPP, PE), paper, cardboard, aluminum which are normally used in the paper industry and/or packaging. In this case the thicknesses are thinner and generally <1 mm.

In accordance with one aspect of the invention, said anti-abrasion and/or anti-scratch layer is applied on at least another intermediate layer consisting of a decorative layer which in turn is applied on at least a part of the surface of the substrate face or on the entire surface of the substrate face.

In accordance with a further aspect of the invention, the decorative layer is applied to one or more intermediate layers such as, for example, at least one layer of stucco (putty) and/or to at least one layer of adhesion primer and/or to at least one layer of print primer and/or at least one layer of colored base.

According to a further embodiment which can be supplied in any combination or in combination with one or more of the previous embodiments, on the anti-wear layer and/or on the anti-scratch layer it is possible to apply a further finishing layer, for example, a layer capable of varying the gloss of the surface of the finished panel.

As will appear in more detail below, the different layers listed above according to the different combinations of the embodiments listed above and the composition chosen for said one or more anti-wear and/or anti-scratch layers and/or for any further layer can be applied using one or more state-of-the-art application techniques, such as, but not limited to, roller, spatula, spray, curtain, blade (knife coater), slot-die and/or by digital application, especially inkjet.

In addition to direct application, the formulation object of the invention can be applied indirectly through transfer technology. In fact, the formulation object of the invention could be applied on a transfer element and once polymerized it could be transferred onto the panel through the sole action of heat and/or pressure or with the aid of an adhesive, as fully described in WO2022144944A1.

As will appear in more detail later, in a preferred embodiment of the formulation, the anti-wear and/or anti-scratch layer is preferably applicable by coating and/or spatulating and/or by printing which does not require spray application.

According to one embodiment, the panel according to the present invention comprises at least one anti-wear and/or anti-scratch layer with a thickness varying from about 50 to 800 microns, preferably from about 100 to 250 microns.

The photo-curable resins or rather, energy-curable resins, have in common the fact that they polymerize and harden by means of the energy radiated by ultraviolet ray devices and/or by irradiation with EB (Electron Beam) or with the addition of organic peroxides and they are divided into two types based on the cross-linking mechanism:

1) radical, typically made of vinyl monomers and acrylate resins which are divide into different subcategories, such as epoxy-acrylate, urethane-acrylate, polyester-acrylate, polyether-acrylate, amino-acrylate, silicon-acrylate, polyisopren-acrylate, polybutadiene acrylate and acrylate monomers. Among the vinyl monomers we can mention N-vinyl caprolactam (NVC), acryloyl morpholine (ACMO), diethylene glycol divinyl ether (DVE-2), triethylene glycol divinyl ether (DVE-3) and their mixtures.

The term acrylate refers to both acrylate and methacrylate resins.

2) cationic systems such as epoxy resins, polyols and monomers such as oxetanes and vinyl ethers.

More information on photo-crosslinkable systems can be found in the text “Radiation Curing: Science and Technology” (Pappas).

The thermoplastic resins that can be used in combination with photo-crosslinkable systems can be made up, for example, but not limited to:
polybenzimidazole PBI
PC polycarbonate
PE polyethylene
polyethylene terephthalate PET
PMMA polymethyl methacrylate
PP polypropylene
PS polystyrene or polystyrene
PVC polyvinyl chloride
polyamide PA
acrylonitrile butadiene styrene ABS
polylactic acid PLA
PTFE polytetrafluoroethylene
polyethersulfone PES(U)
polyoxymethylene POM
polyvinyl acetate PVAc
SBS resins
SEBS resins
SIS resins
SEPS resins
SEEPS resins
ethylene vinyl acetate EVA copolymer
vinyl acetate VA
TPU thermoplastic polyurethanes
thermoplastic acrylic resins
   mixtures and copolymers of the previous ones. The thermoplastic resins listed above can be functionalized with various chemical groups such as maleic, hydroxyl, carboxyl, amino, isocyanate, glycidyl groups. These groups can participate in secondary reactions (dual-cure) useful for improving the performance of the system itself. For example, the hydroxyl group can react with a CNO group to form a urethane bond, while the —COOH group can react with TGIC (triglycidyl isocyanurate) or with amino groups.

Thermoplastic resins are normally characterized by
Physical fitness, e.g. granules, powder, tablets, flakes.
Glass transition temperature Tg and softening point, useful to understand at which temperature the resin assumes viscous behavior
Molecular weight, useful for understanding the solubility in the photo-crosslinkable formulation.
Fluidity of the molten resin.
Acidity number, useful for understanding compatibility/incompatibility with other chemical species.
Viscosity of the melt or in solution.

Furthermore, depending on the desired thermoplasticity, the choice of thermoplastic resin may be selected by its Tg.

Typically, the thermoplastic resin is used dissolved in the photo-crosslinkable resin between 1% and its solubility limit which is a function of the chemical nature of the resin and its molecular weight.

In another form of the invention, the thermoplastic polymer is not dissolved in the photo-crosslinkable resin but is dispersed therein.

In a preferred form of the invention, the formulation object of the invention comprises one or more photocross-linkable resins, photoinitiators, one or more thermoplastic resins and can contain one or more fillers, such as, for example, aluminum oxide (corundum) to increase its resistance to abrasion, talc to modify its rheology, silica to reduce the gloss, calcium carbonate as a filling filler, pigments to impart colour, additives such as levelers, wetting agents, slippers, rheology modifiers and in general the additives and components commonly used in wood coatings and/or flooring.

In another executive form of the invention, the formulation object of the invention might contain other non-photo-crosslinkable and non-thermoplastic systems such as epoxy, polyurethane, acrylic resins.

In another executive the invention, the formulation object of the invention can undergo a secondary cross-linking process (dual-cure). For example, the reaction between the —CNO and —OH groups can be exploited with the formation of a urethane bond.

The coating cycle object of the invention includes different layers which can vary depending on the substrate and the degree of protection desired.

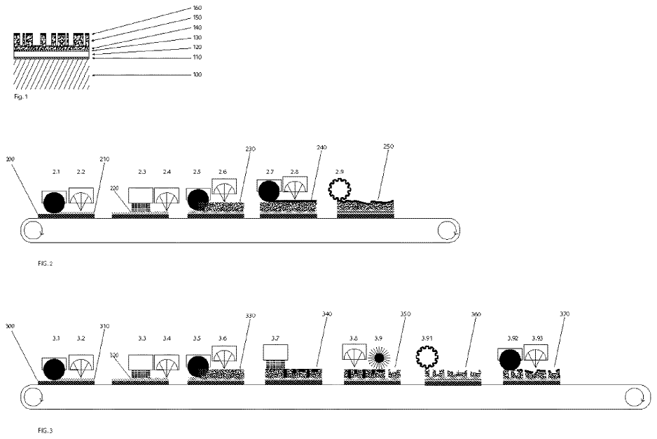

FIG. 1 shows a coating cycle for SPC (Stone Plastic Composite).

According to some embodiments, the coating cycle which is the object of the invention can be carried out using conventional techniques in use, such as roller and/or spray and/or slot-die. For coating rigid flat panels, roller applications using a coating machine are particularly suitable.

Typically, the photo-crosslinkable formulation object of the invention is used to produce furniture and/or floors. The preparation and finishing cycle depends on the material to be decorated and the desired performance.

For example, a typical cycle for the decoration of SPC (Stone Plastic Composite), a material currently in vogue to produce flooring, involves the following processes:

TABLE 1

| Operation | application | guy | g/m² | Note |
|---|---|---|---|---|
| Sanding the | | | | optional |
| substrate | | | | |
| Adhesion | roller | UV | 8/10 | optional |
| primer | | | | |
| White base | roller | UV | 20/40 | one or more applications |
| Print primer | roller | UV | 8/10 | optional |
| Digital print | roller | UV | | |
| Wear layer | roller | UV | 80/200 | One or more |
| | | | | applications. The |
| | | | | quantity depends on the |
| | | | | desired degree of |
| | | | | abrasion resistance |
| Finish | roller | UV | 10/20 | For scratch protection |
| | | | | and to obtain the |
| | | | | desired degree of |
| | | | | opacity |

In order to obtain different aesthetic effects, the wear layer and the finish can have different gloss degrees. In fact, if the wear layer has a higher gloss than the finishing layer, a shiny pore will be obtained which will consequently be highlighted.

On the contrary, if the wear layer and finishing layer have the same level of gloss, the pore will be less evident but with a more natural effect.

In an executive form of the invention, each layer of the coating cycle is made up of the formulation which is the object of the invention.

In a preferred embodiment of the invention the coating cycle involves a heat treatment of the layer(s). Temperature and time are a function of the molecular weight and chemical nature of the resin itself. Typically the heat treatment occurs after the photopolymerization phase. Surprisingly after heat treatment, a matte surface is formed. The heat treatment can take place using hot air or by direct irradiation with IR, NIR rays.

In an executive preferred form of the invention, the decorative layer is generated by inkjet printing directly on the substrate to be decorated.

In another executive form of the invention, the decorative layer is generated by traditional printing directly on the substrate to be decorated.

According to a further embodiment which can be supplied in any combination or in combination with one or more of the previous embodiments, the decorated layer is generated on a film which is then laminated onto the substrate to be decorated. This process is very common for both laminate production and LVT/SPC production. As already mentioned, due to the non-thermoplastic nature of photo-crosslinkable inks, the protection of decorative layers generated with photo-crosslinkable inks, preferably inkjet, cannot be done with traditional technologies such as the application of a polymeric wear layer. The formulation object of the invention is well suited to replacing conventional PVC wear layers, combining performance and the ability to be embossed.

In a preferred form of the invention the formulation object of the invention is mechanically embossed and involves the following steps:
i. application of the photo-crosslinkable formulation
ii. polymerization of the photo-crosslinkable formulation
iii. mechanical embossing
iv. application of the finishing layer (top coating)
v. polymerization of the finishing layer
   Alternatively, the finishing layer can be applied before mechanical embossing:
i. application of the photo-crosslinkable formulation
ii. polymerization of the photo-crosslinkable formulation
iii. application of the finishing layer (top coating)
iv. polymerization of the finishing layer
v. mechanical embossing
vi. further irradiation (optional)
   Preferably, the photo-crosslinkable formulation is well polymerized before being embossed. This avoids detachment from the substrate due to poor adhesion and prevents the photo-crosslinkable formulation from sticking to the embossing element. Optionally, after embossing, the photo-crosslinkable formulation could be irradiated again to complete the polymerization and increase its mechanical properties.

In an executive preferred form of the invention, the embossing element is heated, preferably between 4° and 180° C., the temperature being a function of the composition and softening point of the formulation. Alternatively, the embossing element may not be heated but the cured photo-crosslinkable formulation may be heated prior to the embossing step.

In a further preferred form of the invention, embossing occurs without the need for heating the embossing element and/or the photo-crosslinkable formulation.

In an executive preferred form of the invention the embossing element, continuous or discontinuous, is in turn textured by digital technology and preferably by inkjet.

According to a further embodiment which can be supplied in any combination or in combination with one or more of the previous embodiments the photo-crosslinkable formulation is embossed both mechanically and digitally. In fact, digital embossing (as for example described in WO2020039361A1, although presenting countless advantages, presents some critical issues, especially when the areas to be removed are wide. In fact, for large areas to be removed, there are both brushing issues due to the abundance of material removed and at the same time the removal of the material leads to a decrease in abrasion resistance due to a reduction in the quantity of anti-abrasive photo-crosslinkable formulation. Therefore, it is particularly advantageous to use digital technology in combination to create fine embossing and mechanical embossing for large embossing such as for example, the reproduction of planed and/or saw cuts. Obviously digital embossing will benefit from registering while mechanical embossing will not, however this does not represent a particular limitation as large embossings are often not made in register.

In addition to use to produce architectural materials, the method and formulation object of the invention in any of the embodiments described above, can also be used for the decoration of leather and derivatives and for embellishment, in papermaking, of paper and cardboard or for packaging.

In addition, the method and formulation object of the invention in any of the embodiments described above can be used for the production of functional microstructures such as hydrophobic structures, microchannels and in general for microfluidics.

### BRIEF DESCRIPTION OF THE DRAWINGS

FIG. 1 illustrates the succession of layers to create the decorated panel which is the object of the invention. In particular, the figure represents a decorated panel in plastic material that can be used for flooring:
100 Substrate
110 UV primers (8 g/sqm)
120 UV white base (2×20 g/sqm)
130 UV digital print (8 g/sqm)
140 UV wear layer (30 g/sqm)
150 UV wear layer (30 g/sqm)
160 UV wear layer (150 g/sqm)

FIG. 2 illustrates the process in which the formulation of the invention is mechanically embossed:
200: substrate
210: white base
220: decoration
230: anti-wear coating
240: finish (top coating)
250: embossed layers
2.1, 2.5, 2.7: coating application (coating machine)
2.3: Inkjet printing
2.2, 2.4, 2.6, 2.8: photocrosslinking with UV lamp
2.9: embossing using an engraved cylinder

FIG. 3 illustrates the process object of the invention in which embossing occurs by means of combined mechanical and digital technology:
300: substrate
310: UV white base
320: UV inkjet decoration
330: UV anti-wear coating
340: embossing liquid
350: digitally embossed UV wear-resistant coating
360: Digitally and mechanically embossed UV wear-resistant coating
370: UV finish (top coating)
3.1, 3.5, 3.93: coating application (coating machine)
3.2, 3.4, 3.6, 3.8, 3.93: photocrosslinking with UV lamp
3.3, 3.7: inkjet printing
3.9: Brushing (Digital Embossing)
3.91: embossing using an engraved cylinder

### EXAMPLE 1

A base for the coating is prepared consisting of:
HDDA acrylate monomer: 100% difference
TMPTA acrylate monomer: 20%
acrylate oligomer CN981: 10%
thermoplastic resin (see table 2)
photoinitiator IRGACURE 1173: 3%
TPO photoinitiator: 0.1-5% (5% for blank) Titanium oxide (20%) is then added to the base to prepare the white coating or aluminum oxide (25%) to prepare the anti-abrasive coating.

The line used for decoration and finishing is composed of normal or reverse roller machines for coating application, 6 colors single-pass printer for decoration, single-pass printer for texturing, brushing for texturing. The application and printing speed is 30 m/min.

The white coating is applied by roller with 2 applications of 15 g/m2 to a 2.5 mm SPC substrate and gelled with 2 Ga lamps of 120 W/cm.

The substrate is printed and subsequently a first coat of coating (30 g/m2) gelled with 1 Hg lamp of 120 W/cm is applied and then another application of 150 g/m2 which is textured and gelled with 2 Hg lamps from 120 W/cm. 10 g/m2 of finish is then applied to ensure scratch resistance and the desired shine, the substrate is then dried with 4 120 w/cm Hg lamps.

The substrate has been tested according to EN16511:2019, of which some data are reported:

TABLE 2

| Typology | | Ref. | polyamide | PVC | PVC-Ac | EP |
|---|---|---|---|---|---|---|
| Thermoplastic | | | ORGASOL | SOLVIN | VINNOL | PEW-4 |
| resin | | | 2002 | 550 GA | H 40/50 | |
| Content | % | 0 | 8 | 10 | 10 | 15 |
| Taber | | AC1 | AC4 | AC4 | AC3 | AC2 |
| abrasion | | | | | | |
| Dimensional | 4 h@80 c | NOK | OK | OK | OK | OK |
| stability | | | <1 mm | <1 mm | <1 mm | <1 mm |

### EXAMPLE 2

A anti-abrasive coating is prepared consisting of:
HDDA acrylate monomer: 100% difference
TMPTA acrylate monomer: 20%
acrylate oligomer CN981: 10%
VINNOL H 40/50 (see table 2)
photoinitiator IRGACURE 1173: 3%
TPO photoinitiator: 0.1-5% (5% for blank)
Al2O3 (F220): 25%

The line used for decoration and finishing is made up of normal or reverse roller machines for applying coating, a 6-color single-pass printer for decoration, mechanical embossing using an engraved cylinder. The application and printing speed is 30 m/min.

The white coating is applied by roller with 2 applications of 15 g/m2 to a 2.5 mm SPC substrate and gelled with 2 Ga lamps of 120 W/cm.

The substrate (isocore SPC with 6 mm thickness) is printed and subsequently a coat of anti-abrasive coating (150 g/m2) gelled with 2 Hg lamps of 120 W/cm is applied. 10 g/m2 of finish is then applied to ensure scratch resistance and the desired gloss, the substrate is then dried with 4×120 w/cm Hg lamps. Subsequently, the decorated substrate is embossed with the following conditions:
Embossing cylinder temperature: 60° C.
Distance between embossing cylinder and counter-cylinder: 4.8 mm
   After embossing, the decorated substrate has a well-defined and deep wood grain.

1. Decorated panel comprising:
a. A substrate
b. A decorative layer applied on at least part of the substrate.
c. A radiation curable formulation applied directly or indirectly on a part of the substrate and/or the decorative layer, i.e., with the interposition of further intermediate layers of material on at least a part of the substrate and in one or more layers, containing:
i. At least one energy curable resin
ii. At least one thermoplastic resin
iii. At least one polymerization initiator selected from the group consisting of organic peroxides, UV initiators and electron-beam initiators.

2. Decorated panel according claim 1 where the energy curable resin is selected from cationic energy curable resins, radicalic energy curable resins and/or their combinations or mixtures.

3. Decorated panel according to one or more of any of the preceding claims in which the thermoplastic resin is selected from polybenzimidazole (PBI), polycarbonate (PC), polyethylene (PE), polyethylene terephthalate (PET), polymethyl methacrylate (PMMA), polypropylene (PP), polystyrene (PS) or polystyrene, polyvinyl chloride (PVC), polyamide (PA), SBS resins, SEBS resins, SIS resins, SEPS resins, SEEPS resins, acrylonitrile butadiene styrene (ABS), polylactic acid (PLA), polytetrafluoroethylene (PTFE), polyethersulfone (PES), polyoxymethylene (POM), polyvinyl acetate (PVAc), ethylene vinyl acetate copolymer (EVA), vinyl acetate (VA), thermoplastic acrylic resins, copolymers and/or combinations or mixtures of the foregoing and/or their copolymers, combinations or mixtures.

4. Decorated panel according to one or more of the preceding claims in which the thermoplastic resin is functionalised.

5. Decorated panel according to one or more of the preceding claims in which the thermoplastic resin is functionalised with maleic and/or hydroxyl and/or carboxyl and/or amine and/or isocyanate and/or glycidyl groups.

6. Decorated panel according to one or more of any of the preceding claims in which the radiation curable formulation in is subjected to a secondary polymerization process (dual-cure).

7. Decorated panel according to one or more of any of the preceding claims in which the thermoplastic resin is contained between 1% and its solubility limit in the energy curable formulation.

8. Decorated panel according to one or more of any of the preceding claims in which the energy curable formulation is textured.

9. Decorated panel according to any one or more of the preceding claims, wherein the photocurable formulation is textured, alternatively or in combination, by means of digital and/or mechanical technology.

10. Decorated panel according to one or more of any of the preceding claims in which the decoration is done by means of digital printing.

11. Decorated panel according to one or more of any of the preceding claims in which the radiation curable formulation contains at least one substance selected from water, solvents, surface tension modifiers, acrylic resins, energy curable resins, photoinitiators, slip agents, wetting agents, oils, light stabilizers, antioxidants, antifoams, humectants, biocides, colorants, fillers, aluminum oxide, pigments and mixtures thereof.

12. Decorated panel according to one or more of any of the preceding claims to which the substrate is made up of plastic, wood, wood-derived material (HDF/MDF), metal, fiber cement, ceramic and their combinations.

13. Decorated panel according to one or more of any of the preceding claims to which the decorated panel is used for wall coverings, furniture and flooring production.

14. Method to produce a decorated panel, for floors, coverings or the like, which method includes the steps of:
I) Provide a substrate.
II) applying at least one decorative layer on at least part of the substrate.
III) applying at least one photocurable formulation directly on a part of the substrate and/or of the decorative layer or indirectly on said part of the substrate and/or of said decorative layer, i.e., with the interposition of further intermediate layers of material on at least one part of the substrate and in one or more layers, which crosslinkable formulation comprises:
i. At least one photocurable resin.
ii. At least one thermoplastic resin.
iii. At least one polymerization initiator including but not limited to UV photoinitiators, organic peroxides, electron beam.
iv. Ed wherein at least one further step of three-dimensional shaping of the photo-curable formulation by embossing is provided, which embossing step is provided after the photo-curing step of said photo-curable formulation.

15. Method according to claim 14, wherein the embossing step is performed by mechanical embossing and by digital embossing, or by jetting embossing substances or by both mechanical embossing and digital embossing, said mechanical embossing and said digital embossing being performed in succession.

16. The method according to claim 15, wherein at least the mechanical embossing takes place in combination with heating to a predetermined temperature the mechanical embossing members and/or at least the photocurable formulation.

17. Method according to one or more of claims 14 to 16, wherein the step of applying at least one finishing layer and/or at least one wear layer is provided, the embossing being performed directly on the photocurable formulation before said step application of the at least one finishing and/or wear layer and/or the embossing being performed on said at least one finishing and/or wear layer, optionally following at least partial polymerization of said at least one finishing and/or wear layer.

18. The method according to one or more of the preceding claims 14 to 17, wherein the digital embossing is performed in register with at least part of the patterns reproduced by the decorative layer, while the mechanical embossing is performed out of register with the patterns reproduced by the decorative layer and/or with digital embossing.

19. The method according to one or more of the preceding claims, wherein digital embossing is used to reproduce three-dimensional structures or finer textures than those applied by mechanical embossing.

20. Method according to one or more of the preceding claims, wherein the crosslinking of the formulation takes place alternatively or in combination with the photocrosslinking by means of a so-called dual-cure secondary crosslinking process.
